(19) United States
(12) Patent Application Publication
(10) Pub. No.: US 2008/0076391 A1
(43) Pub. Date: Mar. 27, 2008

(54) METHOD, DEVICE AND SYSTEM FOR IMPLEMENTING PUSH-TO-TALK SERVICE

(75) Inventors: Zhenyu CHEN, Shenzhen (CN); Hao YAO, Shenzhen (CN); Huaqing LIU, Shenzhen (CN); Xinping LV, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/859,483

(22) Filed: Sep. 21, 2007

(30) Foreign Application Priority Data
Sep. 22, 2006 (CN) 200610139727.3

(51) Int. Cl. H04M 3/56; H04M 1/663

(52) U.S. Cl. 455/411; 455/416

(57) ABSTRACT

The present invention discloses a method for implementing a Push-To-Talk (PTT) service, including: establishing a connection between a terminal and a conference room in a conference system with half-duplex communication mode; receiving a request sent by the terminal and providing the PTT corresponding to the request according to a stored corresponding relation between the PTT services and the requests. According to the method, PTT service talk among conference room members or groups in the conference room is implemented. Embodiments of the present invention also disclose another method for implementing the PTT service, as well as a terminal, a conference application server and a system for implementing the PTT service. According to the embodiments of the present invention, the PTT service with wide signal coverage and small call delay is implemented.

This application claims priority to Chinese Patent Application No. 200610139727.3, filed Sep. 22, 2006, which is hereby incorporated by reference.

### FIELD OF THE INVENTION

The present invention relates to Push-To-Talk (PTT) technologies, and more particularly, to a method, device and system for implementing PTT service.

### BACKGROUND OF THE INVENTION

A Push-To-Talk (PTT) service allows a mobile phone with corresponding functions to function as an interphone. Usually, this kind of mobile phone is configured with an interphone button; after the interphone button is pressed, the user may talk with other users or groups by way of half-duplex communication. The users or groups taking part in this talk just need to be within the coverage of the operator network, even if they are far away from each other.

At present, there are two popular methods to implement the PTT service.

One method is based on a special mobile communication system, namely the so called digital trunking system. During a talk, voice data and signaling data are all collected to a pre-established circuit channel for transmission.

The other method is based on a public cellular mobile communication system. This method adopts Voice Over IP (VoIP) technologies to implement high-layer signaling protocol between a mobile terminal and a service application server, and bond the voice data to an IP link for transmission. A typical application of the method is the currently popular PTT over Cellular (PoC) service.

It has been discovered that, because the digital trunking technology is based on a dedicated mobile communication network and the dedicated mobile communication network often has a relatively small signal coverage, the PTT services cannot cover such remote areas as suburbs and mountain areas. Further, since PoC is implemented with VoIP technologies and VoIP has a pretty significant call delay, a PTT service's Quality of Service (QoS) cannot be guaranteed.

### SUMMARY OF THE INVENTION

A method for implementing PTT service includes:

establishing a connection between a terminal and a conference room, the conference room being configured with half-duplex communication mode and set in a telephone conference system;

receiving a request sent by the terminal; and

providing the PTT service corresponding to the request, according to a stored corresponding relation between PTT services and requests.

A conference application server includes:

a storing module, configured to store a corresponding relation between Push-To-Talk services and requests;

a first access module, configured to create a conference room with half-duplex communication mode and establish a connection between a terminal and the conference room;

a service providing module, configured to receive a request sent by the terminal and provide a Push-To-Talk service corresponding to the request.

A terminal includes:

a second access module, configured to establish a connection with a conference room, wherein the conference room is configured with half-duplex communication mode and is set in a conference application server;

a Push-To-Talk service requesting module, configured to request the conference application server for a corresponding Push-To-Talk service through a terminal button.

A system for implementing PTT service comprises a conference application server and terminal device provided by the embodiment of the present invention.

### BRIEF DESCRIPTION OF THE DRAWINGS

FIG. 1 is a flowchart illustrating a method for implementing the PTT services in an embodiment of the present invention.

FIG. 2 is a schematic diagram illustrating a system for implementing the PTT services in an embodiment of the present invention.

FIG. 3 is a schematic diagram illustrating a conference application server for implementing the PTT services in an embodiment of the present invention.

FIG. 4 is a schematic diagram illustrating the terminal device for implementing the PTT services in an embodiment of the present invention.

### DETAILED DESCRIPTION OF THE INVENTION

To make objects, technical solutions and advantages of the present invention clearer, the present invention will be described in detail hereinafter with reference to the drawings and embodiments.

The embodiments of the present invention provide a method, terminal, conference application server and system for implementing the Push-To-Talk (PTT) services based on a telephone conference system. According to the embodiments of the present invention, a conference room with half-duplex communication mode is set in the telephone conference system and buttons corresponding to PTT service requests are set in the terminal; the telephone conference system establishes a connection between the terminal and the corresponding conference room; the terminal accessing the conference room may request the telephone conference system for the PTT service by pressing the corresponding button, to talk with other members in the conference room or the group.

Principle of the telephone conference is that, a soft switch system establishes the connection between conference members from various geological locations and the telephone conference system. After accessing the telephone conference system, the conference room members can talk with other conference room members or groups in a straightway and full-duplex mode. The soft switch system includes: a media gateway device and a soft switch device.

The signaling flow procedure of the terminal accessing the telephone conference system is: a conference room member dials a conference access number using an ordinary telephone to initiate a call to the telephone conference system; the call reaches the media gateway device through a Public Switch Telephone Network (PSTN) and then reaches the soft switch device; the soft switch device analyzes the called number and send the call to the corresponding telephone conference system; the telephone conference system performs operations, such as resource application, according to the call from the terminal; and the terminal succeeds in accessing the telephone conference system if the resource is successfully applied.

In the embodiment of the present invention, the soft switch system comprising various media gateway devices and soft switch devices provides the access service for various kinds of terminals, the telephone conference system provides the PTT service for terminals accessing the telephone conference system, and all conference room members access the telephone conference system through their own terminals. Because there is a corresponding relation between a conference room member and a terminal through which the conference room member accesses the telephone conference system, for the convenience of description, a conference room member and a terminal are equivalent in the specific embodiments below.

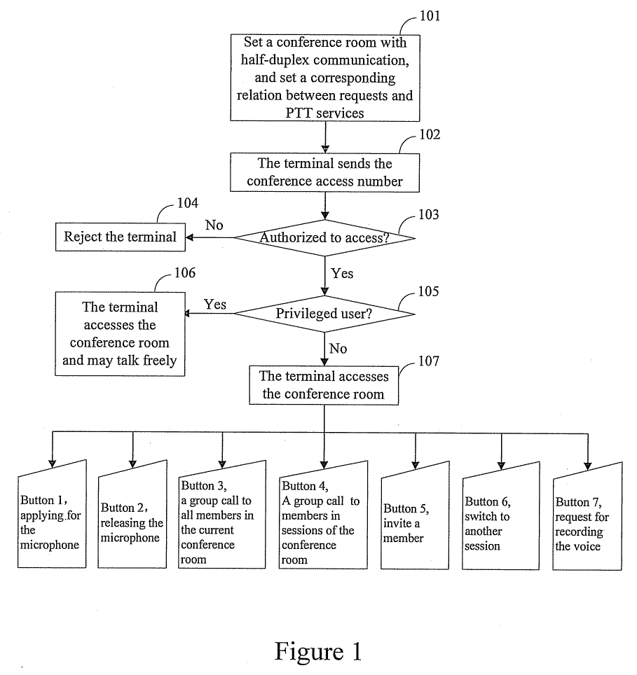

FIG. 1 is a flowchart illustrating the method for implementing the PTT service in the embodiment of the present invention. With reference to FIG. 1, the method includes the following.

Block 101: a conference room with half-duplex communication mode is set in the telephone conference system, and buttons corresponding to the PTT service requests are set in the terminal.

One or more conference rooms may be created in the telephone conference system by the same way as that of the prior art. Because the member relationship in the PTT service is relatively constant, the conference room may be set with fixed conference room members. The conference rooms and the conference room members thereof may be maintained and grouped by means of WEB.

The communication mode of the existing telephone conference system is full-duplex communication. In the conference room with half-duplex communication mode set in the embodiment of the present invention, the terminal cannot speak until it obtains a corresponding PTT service authority. The conference room discards media data from the terminal without the service authority, and plays media data from the terminal with the service authority to other conference room members in the conference room.

The terminal buttons set in this block, which are corresponding to the PTT service requests, are used by the terminal to request the telephone conference system for corresponding PTT service authorities. The conference room member may be informed of the terminal buttons by way of Interactive Voice Response (IVR) button or by other ways. Hereby, a PTT service request may be at least one of the following requests: a request for applying for a microphone, a request for releasing the microphone, a request for inviting a member, a request for deleting a member, a request for a group call to all members in the current conference room, a request for a group call to members of the session of the current conference room, a request for muting, a request for recording the voice, a request for shutting down the current conference room and a request for switching to another session. Practically, other PTT service requests may also be added according to practical application requirements.

Block 102: the terminal sends a conference access number to the telephone conference system to access the telephone conference system.

In the block 102, the terminal may either send the conference access number including both the access number and the conference Identity (ID) to the telephone conference system, or send the access number to telephone conference system before sending the conference ID upon a prompt from the telephone conference system. The telephone conference system may also require the conference room member to input a password. In this embodiment, the access number is the identifier of the telephone conference system, and is a number provided by the telephone conference system for the conference room member to access the telephone conference system; the conference ID is an identifier of the conference room in the telephone conference system.

Block 103: the telephone conference system authenticates the terminal, if the authentication is unsuccessful, that is, the terminal has not the authority of accessing the telephone conference system, the process advances to block 104; otherwise, the process advances to block 105.

In the block 103, the telephone conference system may authenticate the terminal according to the number of the terminal; the telephone conference system may also authenticate the terminal trying to access the telephone conference system according to the password and conference ID input by the conference room member.

For example, the telephone conference system may store in advance all the terminal numbers that have authorities to access the telephone conference system. When receiving the access number from a terminal, the telephone conference system compares the number of the terminal trying to access with the stored terminal numbers. If the number of the terminal matches a stored terminal number, it is determined that the terminal trying to access has a authority to access the telephone conference system, the authentication is successful and block 105 is executed subsequently; otherwise, it is determined that the terminal trying to access has not a authority, the authentication is unsuccessful and block 104 is executed subsequently.

Alternatively, the telephone conference system may store in advance the passwords that are authorized to access the telephone conference system. When receiving a password from a terminal, the telephone conference system compares the password input by the terminal with the stored passwords. If the password matches a stored password, it is determined that the terminal trying to access has a authority to access the telephone conference system, the authentication is successful and block 105 is executed subsequently; otherwise, it is determined that the terminal trying to access has not a authority to access the telephone conference system, the authentication is unsuccessful and block 104 is executed subsequently.

Block 104: the terminal is prevented from accessing the telephone conference system and the process is terminated.

Block 105: the telephone conference system judges whether the conference room member trying to access this telephone conference system is a privileged member; if the conference room member trying to access this telephone conference system is a privileged member, the process advances to block 106; otherwise, the process advances to block 107.

The telephone conference system may store in advance terminal numbers or passwords of the privileged members and then, by means of the similar method of authenticating the terminal in block 103, judges whether the member trying to access this telephone conference system is the privileged member.

Block 106: the connection is established between the terminal and the corresponding conference room, and the conference room member using this terminal is allowed to speak without restriction.

In this block, the telephone conference system establishes the connection between the terminal and the corresponding conference room according to the conference ID in the conference access number sent by the terminal. Since the conference room member using this terminal is the privileged member, the conference room member using this terminal does not need to apply for the microphone before speaking; the telephone conference system plays all media data from this privileged member to all terminals in this conference room, and the privileged member may speak in the conference room without any restriction. The PTT service based on the telephone conference system is implemented.

Block 107: the connection is established between the terminal and the corresponding conference room, and the corresponding PTT services are provided according to the pressed button in the terminal.

The telephone conference system establishes the connection between the terminal and the corresponding conference room according to the conference ID included in the conference access number sent by the terminal, and provides the corresponding PTT services according to the pressed button in the terminal.

An example, in which 7 IVR buttons are set to correspond to various PTT service requests according to Block 101, will be described to explain how to provide the PTT services.

Button 1 corresponds to the request for applying for a microphone. Terminal numbers or passwords authorized to apply for the microphone may be set in the telephone conference system, or all the conference room members may be authorized to apply for the microphone. Pressing button 1 of the terminal means applying for the microphone; and if other members of this conference room are applying for speaking, this application is invalid.

Button 2 corresponds to the request for releasing the microphone. After finishing speaking, the member presses the button 2 to release the microphone. Two separate buttons may be set to respectively correspond to the requests for applying for the microphone and releasing the microphone. Alternatively, one button may be set, wherein pressing the button means applying for the microphone and releasing the button means releasing the microphone. For example, a special dial unit may be set at the terminal, and a button corresponding to this dial unit may be set at a keypad of the terminal. The button is normally open. When the button is pressed, the dial unit sends to the telephone conference system a request for applying for the microphone; when this button is released, the dial unit sends to the telephone conference system a request for releasing the microphone. Therefore, it is convenient for the user.

In additional, in order to prevent the button corresponding to the request for apply for the microphone from being pressed by a common conference room member for such a long time that other conference room members cannot apply for the microphone, a speaking timer may be set in the telephone conference system, wherein this speaking timer's overtime duration may be set and modified by way of WEB. If the telephone conference system detects that a conference room member's speaking time exceeds the overtime duration, the telephone conference system withdraws the microphone. In addition, a silence timer may be set in the telephone conference system, wherein the silence timer's overtime duration may be set and modified by way of WEB. When detecting that a conference room member with the microphone has been quiet for a long time, the telephone conference system withdraws the microphone.

Button 3 corresponds to the request for a group call to all the members in the current conference room. The terminal numbers or passwords authorized to initiate a group call to all the conference room members in the current conference room may be set in the telephone conference system. When the button 3 of the terminal authorized to initiate a group call to all the members is pressed, all conference room members in the current conference room are called. Furthermore, when a privileged member presses the button 3, the called conference room members in sessions will be directly added to the primary conference room.

Button 4 corresponds to the request for a group call to the conference room members in a session of the current conference room. The terminal numbers or passwords authorized to initiate a group call to the conference room members in the session of the current conference room may be set in the telephone conference system. When the button 4 of the authorized terminal is pressed, the telephone conference system prompts that an identity of the called session is to be inputted, and the conference room members in the session with the inputted identity of the current conference room are called.

Button 5 corresponds to the request for inviting a conference room member. The terminal numbers or passwords authorized to invite a conference room member may be set in the telephone conference system. When the button 5 of the authorized terminal is pressed, the telephone conference system will prompt that the number of the invited conference room member is to be inputted, and the conference room member with the inputted number is called. Hereby, the called conference room member may be either a registered member or an unregistered member of this conference room.

Button 6 corresponds to the request for switching to another session. The terminal numbers or passwords authorized to switch to another sub session may be set in the telephone conference system. When the button 6 of the authorized terminal is pressed, the terminal requests for switching to another session; the telephone conference system prompts the terminal to input an identifier of the target session. Alternatively, the telephone conference system may automatically split the conference. Thus switching communication group according to specific requirement is implemented.

Button 7 corresponds to the request for recording the voice. The terminal numbers or passwords authorized to record the voice may be set in the telephone conference system. When the button 7 of the authorized terminal is pressed, the terminal requests for recording the voice, and the telephone conference system starts to perform relevant recording operations.

The above mentioned PTT services are examples of the present invention. In practical applications, other buttons may be set to accomplish other functions, such as deleting a member, muting the voice, shutting down the conference and so on, and terminal numbers or passwords authorized to perform such functions may be set in the telephone conference system. In addition, a corresponding relationship between various PTT services and the priorities of the terminal numbers or the passwords may be set in the telephone conference system, wherein the corresponding relationship may be modified and maintained by way of WEB. When receiving a same PTT service from more than one terminal, the telephone conference system determines the terminal with the highest priority according to the corresponding relationship between the PTT services and the priorities of the terminal numbers or the passwords, and provides the requested service for the terminal with the highest priority.

Therefore the PTT service based on the telephone conference system according to the embodiment of the present invention is implemented.

Corresponding to the above described method for providing the PTT service based on the telephone conference system, the embodiments of the present invention provide a terminal, a conference application server and a system for implementing the PTT service. Hereinafter, the terminal, the conference application server and the system for implementing the PTT service will be described in detail with reference to specific embodiments.

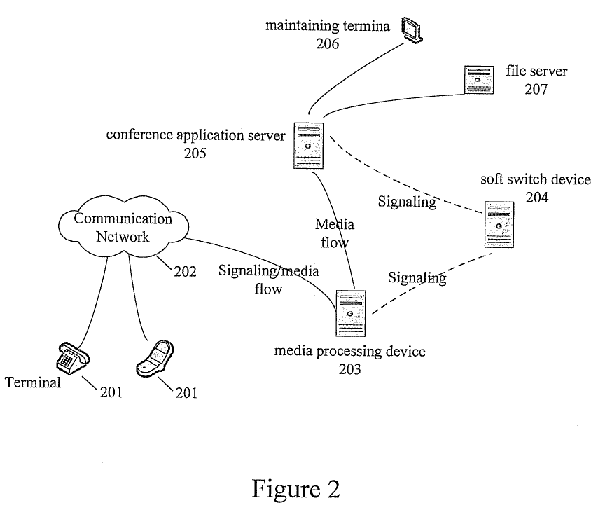

FIG. 2 is a schematic diagram illustrating the system for implementing the PTT service in the embodiment of the present invention. As shown in FIG. 2, this system includes a terminal 201, a communication network 202, a media processing device 203, a soft switch device 204, a conference application server 205, a maintaining terminal 206 and a file server 207. The conference application server 205 corresponds to the telephone conference system in the method of the embodiment of the present invention.

The terminal 201 is configured to send a conference access number and a conference ID to the communication network 202, access the conference application server 205 through the communication network 202, the media processing device 203 and the soft switch device 204, and request the conference application server 205 for PTT services by pressing the buttons after accessing a conference room of the conference application server 205.

The communication network 202 is configured to forward the conference access number and the conference ID received from the terminal 201 to the soft switch device 204, and transmit the media flow between the terminal 201 and the media processing device 203.

The media processing device 203 is configured to transmit the media flow between the terminal 201 and the conference application server 205 as well as the signaling flow between the terminal 201 and the soft switch device 204.

The soft switch device 204 is configured to establish the connection between the terminal 201 and the corresponding conference application server 205 according to the access number of the terminal 201.

The conference application server 205 is configured to create the conference rooms with half-duplex communication mode, store the corresponding relation between the terminal buttons and the PTT services, authenticate the terminal 201 trying to access the conference application server 205, establish the connection between the terminal 201 and the corresponding conference room according to the conference ID inputted by the terminal 201 after the terminal 201 is authenticated, and provide corresponding PPT services according to the pressed buttons of the terminal 201.

The maintaining terminal 206 is configured to maintain the conference application server 205, e.g. maintain the conference room, the members in the conference room and so on.

The file server 207 is configured to store the PTT service data, the conference room data, the member data, the member authority, the password data and so on.

In practical application, the conference application server 205 may prompt the terminal 201 to input a password while authenticating the terminal 201. Further more, some additional functions of the conference system, such as releasing the microphone, inviting the member, deleting the member, making a group call to all the members in the current conference room, making a group call to all the members in a certain session of the current conference room, muting, recording, shutting down the conference, switching to another session and so on, may be added to the conference application server 205 according to specific requirements, and terminal numbers or passwords that are authorized to perform these functions as well as the corresponding member priorities may be set in the system. Both the corresponding relation between the PTT service functions and the authorities and the corresponding relation between the PTT service functions and the member priorities may be maintained and modified through the maintaining terminal 206 and/or the file server 207.

In addition, a special dial unit may be set at the existing terminal in practical application and a button corresponding to this dial unit may be set at a keypad of the terminal. The button is normally open. When the button is pressed, the dial unit sends to the telephone conference system a request for applying for the microphone; when this button is released, the dial unit sends to the telephone conference system a request for releasing the microphone. This dial unit may be set at the terminal or at an accessory of this terminal, such as an ear phone of this terminal. Taking a mobile phone terminal for example, this dial unit may be set inside the mobile phone or at the mobile phone's ear phone for the user's convenience.

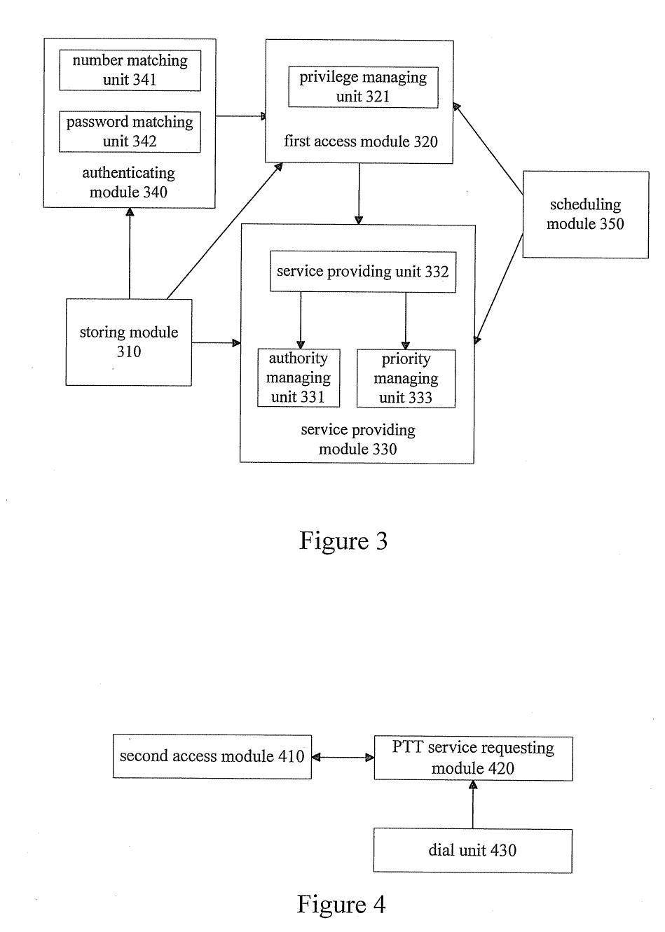

FIG. 3 is a schematic diagram illustrating the conference application server for implementing the PTT service in the embodiment of the present invention. With reference to FIG. 3, this conference server includes: a storing module 310, a first access module 320 and a service providing module 330.

The storing module 310 is used for storing the corresponding relation between the PTT services and the terminal buttons, i.e. the corresponding relation between the PTT services and the requests corresponding to the terminal buttons.

The first access module 320 is used for creating the conference rooms with half-duplex communication mode and establishing the connection between the terminal and the conference room.

The service providing module 330 is used for receiving the request sent by the terminal and providing the PTT service corresponding to the request.

The conference application server shown in FIG. 3 may further include a authenticating module 340, which is used for receiving the conference access number sent by the terminal, authenticating the terminal and notifying the first access module 320 when the authentication is successful. In this case, the first access module 320 establishes the connection between the terminal and the conference room according to the notification from the authenticating module 340.

Further more, the storing module 310 shown in FIG. 3 may store all the terminal numbers that are authorized to assess the conference room; the authenticating module 340 may further include a number matching unit 341, which is adapted to compare the number of the terminal trying to access the conference room with the stored terminal numbers and notify the first access module 320 when the number of the terminal matches one of the stored terminal numbers.

Further more, the storing module 310 shown in FIG. 3 may store all the passwords that are authorized to assess the conference room; the authenticating module 340 may further include a password matching unit 342, which is adapted to compare the password sent by the terminal with the stored passwords and notify the first access module 320 when the password sent by the terminal matches one of the stored passwords.

Further more, the storing module 310 shown in FIG. 3 may store all the terminal numbers and/or passwords of the privileged terminals; the first access module 320 may further include a privilege managing unit 321. The privilege managing unit 321 may compare the number of the terminal to the stored terminal numbers of the privileged terminals; if the number of the terminal matches one of the stored terminal numbers of the privileged terminals, the privilege managing unit 321 determines the terminal as a privileged terminal and plays all the media data from the privileged terminal to all terminals in the conference room.

Further more, the storing module 310 shown in FIG. 3 may store the corresponding relation between the PTT services and the authorities of the terminal numbers or the passwords. The service providing module 330 may further include: a authority managing unit 331 and a service providing unit 332. According to the corresponding relation between the PTT services and the authorities of the terminal numbers or the passwords as well as the corresponding relation between the PTT service requests and the PTT services, the authority managing unit 331 judges whether the terminal sending the request is authorized for the requested PTT service, and notifies the service providing unit 332 when the terminal is authorized for the requested PTT service, the authority managing unit 331; the service providing unit 332 provides the corresponding PTT service to the terminal according to notification of the authority managing unit 331.

Further more, the storing module 310 shown in FIG. 3 may store the corresponding relation between the PTT service and the priorities of terminal numbers or the passwords; the service providing module 330 may further include a priority managing unit 333. According to the corresponding relation between the PTT services and the priorities of the terminal numbers or the passwords, the priority managing unit 333 determines the terminal with the highest priority and then notifies the service providing unit 332 of the terminal with the highest priority; the service providing unit 332 provides the corresponding PTT service to the terminal according to notification of the priority managing unit 333.

Further more, the conference application server shown in FIG. 3 may include a scheduling module 350, which is used to schedule multiple conference rooms in the conference application server, and to control the first access module 320 in establishing the connection for the terminal.

FIG. 4 is a schematic diagram illustrating the terminal for implementing the PTT service in the embodiment of the present invention. With reference to FIG. 4, this terminal includes: a second access module 410 and a PTT service requesting module 420.

The second access module 410 is used to access the conference room, wherein the conference room is configured with half-duplex communication mode and is set in the conference application server. The PTT service requesting module 420 is used to request the conference application server for corresponding PTT service through the terminal buttons.

As described above, the terminal may further include: a dial unit 430 and a button corresponding to the dial unit 430. The dial unit 430 is used to, when the button corresponding to the dial unit 430is pressed, send a request for applying for the microphone to the conference application server and, when the button corresponding to the dial unit 430is released, send a request for releasing the microphone to the conference application server.

It may be seen from the above embodiments that, conference rooms with half-duplex communication mode are set in the telephone conference system and buttons corresponding to requests for PTT services are set in the terminal; the telephone conference system establishes the connection between the terminal and the corresponding conference room; thereafter, the terminal accessing the conference room may request the telephone conference system for corresponding PTT services by pressing corresponding buttons, such as applying for the microphone and so on, and talk with other conference room members or groups. Therefore, the PTT services are implemented based on the telephone conference system so as to benefit from the wide signal coverage of the mobile network and void the large call delay of the PoC technology.

It may be seen from the above technical schemes that, in the embodiments of the present invention, a conference room with half-duplex communication mode is set in the telephone conference system, and terminal buttons are set to correspond to PTT service requests; thereafter the telephone conference system establishes the connection between the terminal and the corresponding conference room; therefore, the terminal accessing the conference room may request the telephone conference system of corresponding PTT service by way of the terminal buttons, and further talk with other members in the conference room or groups. Therefore, based on a conference system, a simple PTT service is implemented.

By making use of the characteristic that the mobile network has wider signal coverage than the traditional PTT service network, the embodiments of the present invention implement a PTT service with wide coverage; furthermore, by making use of the characteristic that the QoS of the conference system is more reliable than that of a VoIP-based PoC, the embodiments of the present invention implement a PTT service with small call delay.

The above illustration is just embodiments of the present invention and not intended to limit the present invention. Any modification, equivalent substitute and improvement within the spirit of the present invention are in protection scope of the present invention.

What is claimed is:

1. A method for implementing a Push-To-Talk (PTT) service, comprising:
establishing a connection between a terminal and a conference room, the conference room being configured with half-duplex communication mode and set in a telephone conference system;
receiving a request sent by the terminal; and
providing the PTT service corresponding to the request, according to a stored corresponding relation between PTT services and requests.

2. The method according to claim 1, wherein, the process of establishing the connection between the terminal and the conference room comprises:
receiving a conference access number sent by the terminal;
authenticating the terminal; and
establishing the connection between the terminal and the conference room.

3. The method according to claim 2, wherein, the conference access number comprises an access number for identifying the telephone conference system and a conference identity for identifying the conference room;
wherein the process of receiving the conference access number sent by the terminal comprises:
receiving the access number and the conference identity sent by the terminal; or, after receiving the access number sent by the terminal, prompting the terminal to send the conference identity, and
receiving the conference identity sent by the terminal;
wherein the process of establishing the connection between the terminal and the conference room comprises:
establishing the connection between the terminal and the conference room corresponding to the conference identity.

4. The method according to claim 2, wherein terminal numbers authorized to access the telephone conference system are stored in advance; and
the process of authenticating the terminal comprises:
comparing number of the terminal with the stored terminal numbers, and determining that the terminal is successfully authenticated when the number of the terminal matches one of the stored terminal numbers.

5. The method according to claim 2, wherein passwords authorized to access the telephone conference system are stored in advance;
after receiving the conference access numbers sent by the terminal, the method further comprises:
prompting the terminal to send the password;
and the process of authenticating the terminal comprises:
comparing the password sent by the terminal with the stored passwords, and determining that the terminal is successfully authenticated when the password sent by the terminal matches one of the stored passwords.

6. The method according to claim 5, wherein, the terminal numbers or the passwords of privileged terminals are stored in advance;
before establishing the connection between the terminal and the conference room, the method further comprises:
comparing number of the terminal with the stored terminal numbers, and when the number of the terminal matches one of the stored terminal numbers, determining the terminal as a privileged terminal and playing all media data from the privileged terminal to all other terminals in the conference room; or comparing the password sent by the terminal with the stored passwords, and when the password sent by the terminal matches one of the stored passwords, determining the terminal as a privileged terminal and playing all media data from the privileged terminal to all other terminals in the conference room.

7. The method according to claim 5, wherein, a corresponding relation between the PTT services and the terminal numbers or the passwords is stored in advance;
before providing the PTT service corresponding to the request, the method further comprises:
according to the corresponding relation between the PTT services and the terminal numbers or the passwords, and the corresponding relation between the PTT services and the requests, judging whether a terminal sending the request is authorized for a requested PTT service; and
providing the requested PTT service when the terminal sending the request is authorized for the requested PTT service.

8. The method according to claim 6, wherein, a corresponding relation between the PTT services and priorities of the terminal numbers or the passwords is stored in advance;
and when receiving from multiple terminals the requests for a same PTT service, the method further comprises:
according to the corresponding relation between the PTT services and the priorities of the terminal numbers or the passwords, finding a terminal with the highest priority and providing the corresponding PTT service to the terminal with the highest priority.

9. A conference application server, comprising:
a storing module, configured to store a corresponding relation between Push-To-Talk services and requests;
a first access module, configured to create a conference room with half-duplex communication mode and establish a connection between a terminal and the conference room;
a service providing module, configured to receive a request sent by the terminal and provide a Push-To-Talk service corresponding to the request.

10. The conference application server according to claim 9, wherein the conference application server further comprises:
an authenticating module, configured to receive a conference access number sent by the terminal, authenticate the terminal, and notify the first access module via a notification when the authentication is successful;
wherein the first access module establish the connection between the terminal and the conference room according to the notification received from the authenticating module.

11. The conference application server according to claim 10, wherein the storing module stores terminal numbers authorized to assess the conference room; and
the authenticating module further comprises:
a number matching unit, configured to compare number of the terminal with the stored terminal numbers, and notify the first access module when the number of the terminal matches one of the stored terminal numbers.

12. The conference application server according to claim 10, wherein the storing module stores passwords authorized to assess the conference room; and
the authenticating module further comprising:
a password matching unit, configured to compare a password sent by the terminal with the stored passwords, and notify the first access module when the password sent by the terminal matches one of the stored passwords.

13. The conference application server according to claim 12, wherein the storing module stores terminal numbers or passwords of privileged terminals; and
the first access module further comprises a privilege managing unit;
wherein the privilege managing unit is configured to compare number of the terminal with the stored terminal numbers of the privileged terminals, and determine the terminal as a privileged terminal and play all media data from the privileged terminal to all other terminals in the conference room when the number of the terminal matches one of the stored terminal numbers of the privileged terminals; or the privilege managing cell is configured to compare the password sent by the terminal with the stored passwords of the privileged terminals, and determine the terminal as a privileged terminal and play all media data from the privileged terminal to all other terminals in the conference room when the password sent by the terminal matches one of the stored passwords of the privileged terminals.

14. The conference application server according to claim 12, wherein the storing module stores a corresponding relation between Push-To-Talk services and authorities of the terminal numbers or the passwords; and the service providing module further comprises an authority managing unit and a service providing unit;
wherein the authority managing unit is configured to judge, according to the corresponding relation between the Push-To-Talk services and the authorities of the terminal numbers or the passwords and the corresponding relation between the Push-To-Talk services and the requests, whether the terminal sending the request is authorized for the requested Push-To-Talk service, and notify the service providing unit via a notification when the terminal sending the request is authorized for the requested Push-To-Talk service; and
the service providing unit is configured to provide the requested Push-To-Talk service to the terminal sending the request according to the notification of the authority managing cell.

15. The conference application server according to claim 12, wherein, the storing module stores a corresponding relation between Push-To-Talk services and the priorities of the terminal numbers or the passwords; and the service providing module further comprises a priority managing unit and a service providing unit;
wherein the priority managing unit is configured to determine, according to the corresponding relation between the Push-To-Talk services and the priorities of terminal numbers or the passwords, a terminal with the highest priority, and notify the service providing unit via a notification of the terminal with the highest priority; and
the service providing unit is configured to provide corresponding Push-To-Talk service to the terminal with the highest priority according to notification from the priority managing unit.

16. The conference application server according to claim 9, wherein the conference application server further comprises:
a scheduling module, configured to schedule multiple conference rooms in the conference application server and control the first access module.

17. A terminal, comprising:
a second access module, configured to establish a connection with a conference room, wherein the conference room is configured with half-duplex communication mode and is set in a conference application server;
a Push-To-Talk service requesting module, configured to request the conference application server for a corresponding Push-To-Talk service through a terminal button.

18. The terminal according to claim 17, wherein the terminal further comprises a dial unit and a button corresponding to the dial unit; wherein
the dial unit is configured to send to the conference application server a request for applying for a microphone when the button corresponding to the dial unit is pressed, and send to the conference application server a request for releasing the microphone when the button corresponding the dial unit is released.

19. A system for implementing a Push-To-Talk service, comprising the conference application server according to claim 9 and the terminal device according to claim 17.
